(19) United States
(12) Patent Application Publication
(10) Pub. No.: US 2016/0245404 A1
(43) Pub. Date: Aug. 25, 2016

(54) DEVICE FOR AN EMERGENCY PARK RELEASE SELECTOR

(71) Applicant: JAGUAR LAND ROVER LIMITED, Coventry, Warwickshire (GB)

(72) Inventor: Dan Barclay, Coventry, Warwickshire (GB)

(21) Appl. No.: 15/030,494

(22) PCT Filed: Oct. 22, 2014
(86) PCT No.: PCT/EP2014/072641

§ 371 Date: Apr. 19, 2016

(30) Foreign Application Priority Data
Oct. 29, 2013 (GB) 1319041.8

(51) Int. Cl. F16H 63/34

(52) U.S. Cl. CPC F16H 63/3491

(57) ABSTRACT

A mechanism for releasing an electronically controlled automatic transmission from a parking position, the automatic transmission comprising a selector shaft for selecting an operating position of the automatic transmission, the mechanism comprising a manual actuator coupled to a release lever by a cable, the release lever being coupled to the selector shaft such that the selector shaft is rotatable with respect to the release lever up to a predetermined angle.

### TECHNICAL FIELD

The present invention relates to an automatic transmission system having an emergency park release selector and particularly, but not exclusively, to a device for introducing free play into the system. The invention finds advantageous application in automotive applications but may be employed in other applications such as but not limited to industrial and marine applications. Aspects of the invention relate to a mechanism, to a driving position selector, to an automatic transmission, to a vehicle and to a method.

### BACKGROUND

It is known to provide a vehicle with an automatic transmission system typically such systems employ a driving position selector to shift between the four driving positions; ‘park’ (P), ‘reverse’ (R), ‘neutral’ (N) and ‘drive’ (D). A mechanical linkage may couple the driving position selector and a control device such as shift lever disposed in the vehicle cabin. Recently “shift-by-wire” transmission systems have been developed; “shift-by-wire” is an electromechanical or electrohydraulic system which replaces the mechanical linkage between the automatic transmission system and the shift lever in the vehicle cabin. In a shift-by-wire transmission system shifting between the four driving positions; ‘park’, ‘reverse’, ‘neutral’ and ‘drive’ is electronically controlled.

Typically, when a shift-by-wire automatic transmission system disengages park, the hydraulic pressure withdraws a park rod from a park pawl and so releases a park pawl tooth from a park wheel. In this condition the ‘neutral’, ‘drive’ or ‘reverse’ gear selections can now be selected. These system interactions often require a high pressure to overcome the park system loads and so any external loads must be kept to a minimum so as not to exceed the transmission limits.

It is known in shift-by-wire transmission systems for the transmission system to default to the ‘park’ position in the event of a loss of electrical power. Other systems may remain in the driving position selected at the time of the loss of electrical power, which may be the park position. It is therefore desirable to provide an Emergency Park Release (EPR) mechanism such that the vehicle can be moved under such conditions. The Emergency Park Release mechanism may be employed in other situations in which the driving position selector fails to operate and the parking position is engaged. Typically, the Emergency Park Release mechanism comprises a selector lever coupled to a selector shaft which forms part of the transmission system. The selector lever is coupled by a cable, such as a Bowden cable, to a release lever or handle. The release lever or handle is typically disposed in the vehicle cabin or engine bay. The release lever or handle is manually operated to disengage the parking position.

When the shift-by-wire transmission system is operated electronically each disengagement & re-engagement of ‘park’, rotates the selector shaft, thus forcing the EPR selector lever to rotate and forcing the EPR cable system to cycle through its nominal routing. This imposes an unwanted additional load on the park system hydraulics and park return spring through, compression loads in springs and bellows and friction load in the Bowden cable. As such, it is desirable to provide a free-play device at this interface to assume negligible load from the EPR to the park system hydraulics and park return spring.

The present invention seeks to provide an improvement in the field of emergency park release systems for automatic transmissions that has particular application for vehicles. The invention may be utilised in applications other than for vehicles.

### SUMMARY

Aspects of the invention provide a mechanism, a driving position selector, an automatic transmission, a vehicle and a method as claimed in the appended claims.

According to one aspect of the invention for which protection is sought, there is provided a mechanism for releasing an electronically controlled automatic transmission from a parking position, the automatic transmission comprising a selector shaft for selecting an operating position of the automatic transmission, the mechanism comprising a manual actuator coupled to a release lever by a cable, the release lever being coupled to the selector shaft such that the selector shaft is rotatable with respect to the release lever up to a predetermined angle.

Advantageously, the mechanism may provide that the park system hydraulics of the automatic transmission are not required to do additional work to overcome system loads (the automatic transmission does not need to move the release lever, compress the cable return spring or overcome a frictional load when moving the cable) of the emergency park release mechanism when operating normally, that is to say electronically. The emergency park release mechanism is therefore effectively disconnected from the automatic transmission during normal operating conditions.

One of the release lever and the selector shaft may comprise an aperture and the other of the release lever and the selector shaft may comprise a projection received within the aperture, wherein the aperture is shaped such that the selector shaft is rotatable with respect to the release lever up to the predetermined angle.

The selector shaft may be rotatable between a first position in which the automatic transmission is in a parking position and a second position in which the automatic transmission is disengaged from the parking position without rotating the release lever.

The release lever may be mounted upon the selector shaft and comprise an aperture for receiving the selector shaft, wherein the aperture is shaped such that the selector shaft is rotatable with respect to the release lever up to the predetermined angle.

The aperture may be shaped such that further rotation of either one of the release lever or selector shaft causes both the release lever and selector shaft to rotate synchronously.

The aperture shape may be a combination of the cross-sectional shape of the selector shaft at the first position and the cross-sectional shape of the selector shaft after rotation to the second position. The aperture may be substantially butterfly shaped.

The aperture may comprise a first pair of diagonally opposed surfaces for engaging opposing sides of the selector shaft for rotating the selector shaft in a first direction and wherein the diagonally opposed surfaces are arranged so as to engage the selector shaft on opposing sides of the rotational axis of the selector shaft.

The aperture may comprise a second pair of diagonally opposed surfaces for engaging on opposing sides of the selector shaft for rotating the selector shaft in a second direction and wherein the diagonally opposed surfaces are arranged so as to engage the selector shaft on opposing sides of the rotational axis of the selector shaft.

In some embodiments, only one pair of the first and second pairs of diagonally opposed surfaces may be engaged with the selector shaft when the selector shaft is rotated in either of the first or second directions.

The release lever may be coupled to the selector shaft proximate to a first end thereof and to the cable proximate to a second end thereof.

The mechanism may comprise a cable return spring for biasing the cable and the release lever to a non-operative position.

In use, the cable may be arranged to pull the second end of the release lever thereby rotating the release lever about the rotational axis of the selector shaft.

The manual actuator may comprise a latching device for retaining the manual actuator, the cable and the release lever in an operative position when actuated, so as to maintain the selector shaft in the second position.

When the release lever is disposed in a non-operative position, the first pair of diagonally opposed surfaces may be substantially disposed in engagement with the selector shaft when disposed in a parking position such that the selector shaft rotates substantially simultaneously with the release lever when rotated in the first direction.

According to another aspect of the invention for which protection is sought, there is provided a driving position selector for an electronically controlled automatic transmission comprising the mechanism described herein above.

According to a further aspect of the invention for which protection is sought, there is provided an automatic transmission for a vehicle comprising an electronically activated driving position selector having the mechanism described herein above.

The automatic transmission may comprise a housing wherein the selector shaft extends through the housing and the cable is slidably mounted within a bracket mounted upon the housing.

The cable may comprise an end connector for coupling the cable to the release lever and the cable return spring may be mounted between the end connector and the bracket.

The cable return spring may be disposed with a bellows for preventing or reducing ingress of dirt or moisture into the cable.

According to a still further aspect of the invention for which protection is sought, there is provided a vehicle comprising the automatic transmission described in the foregoing paragraphs or the mechanism described herein above.

According to yet a further aspect of the invention for which protection is sought, there is provided a method of releasing an automatic transmission from a park position comprising;
providing an automatic transmission comprising an electronically activated driving position selector, the driving position selector having a selector shaft and a locking mechanism for locking the selector shaft in a park position; and
providing a mechanism for releasing the automatic transmission from a parking position, the mechanism having a release lever;
wherein, in a first mode the method comprises;
   activating the driving position selector electronically;
   rotating the selector shaft between a first position in which the automatic transmission is in a parking condition, and second position in which the automatic transmission is disengaged from the parking condition;
   where, in the first mode the selector shaft rotates with respect to the release lever between the first and second positions; and
in a second mode the method comprises;
   activating the driving position selector manually;
   rotating the release lever in a first direction;
   thereby rotating the selector shaft, synchronously with the release lever, between the first position in which the automatic transmission is in the parking condition, and the second position in which the automatic transmission is disengaged from the parking condition.

In the second mode the method may comprise locking the mechanism to prevent the release lever and selector shaft returning to the first position so as to prevent the automatic transmission engaging the parking condition.

In the second mode the method may comprise unlocking the mechanism to allow the release lever and selector shaft to return to the first position so as to allow the automatic transmission to engage the parking condition.

According to another aspect of the present invention for which protection is sought, there is provided a mechanism for releasing an electronically controlled automatic transmission from a parking position, the automatic transmission comprising a selector shaft for selecting an operating position of the automatic transmission, the mechanism comprising a manual actuator coupled to a release lever by a cable, the release lever being mounted upon the selector shaft and the release lever comprising an aperture for receiving the selector shaft, wherein the aperture is shaped such that the selector shaft is rotatable with respect to the release lever up to a predetermined angle

Optionally, the aperture is shaped such that further rotation of either one of the release lever or selector shaft causes both the release lever and selector shaft to rotate synchronously.

This has the advantage of providing an emergency park release mechanism for releasing the transmission from the park position.

In some embodiments the selector shaft may rotate between a first position in which the automatic transmission is in a parking position and a second position in which the automatic transmission is disengaged from the parking position without rotating the release lever.

Optionally, the aperture shape is a combination of the cross-sectional shape of the selector shaft at the first position and the cross-sectional shape of the selector shaft after rotation to the second position. The aperture may be substantially butterfly shaped.

The aperture may comprise a first pair of diagonally opposed surfaces for engaging on opposing sides of the selector shaft for rotating the selector shaft in a first direction and wherein the diagonally opposed surfaces are optionally arranged so as to engage the selector shaft on opposing sides of the rotational axis of the selector shaft.

Optionally, the aperture may also comprise a second pair of diagonally opposed surfaces for engaging on opposing sides of the selector shaft for rotating the selector shaft in a second direction and wherein the diagonally opposed surfaces are optionally arranged so as to engage the selector shaft on opposing sides of the rotational axis of the selector shaft.

In some embodiments only one pair of the first or second pairs of engaging surfaces is engaged with the selector shaft when rotating the selector shaft in the first or second direction.

The release lever may be coupled to the selector shaft proximate to a first end thereof and may be coupled to the cable proximate to a second end of the selector shaft.

Optionally, the mechanism comprises a cable return spring for biasing the cable to the first position.

In some embodiments the cable is arranged to pull the second end of the release lever whereby rotating the release lever about the rotational axis of the selector shaft.

The manual actuator may comprise a latching device for retaining the manual actuator, cable and the release lever in the second position.

In some embodiments whereupon the release lever is disposed in the first position, the first pair of diagonally opposed surfaces is substantially disposed in engagement with the selector shaft when disposed in a parking position such that the selector shaft rotates substantially simultaneously with the release lever when rotated in the first direction.

According to another aspect of the invention for which protection is sought, there is provided a driving position selector for an electronically controlled automatic transmission comprising the mechanism described herein above.

According to a further aspect of the invention for which protection is sought, there is provided an automatic transmission for a vehicle comprising an electronically activated driving position selector having the mechanism described herein above.

Optionally, the automatic transmission comprises a housing wherein the selector shaft extends through the housing and the cable is slidably mounted within a bracket mounted upon the housing.

Optionally, the cable comprises an end connector for coupling the cable to the release lever and the cable return spring is mounted between the end connector and the bracket.

In some embodiments the cable return spring is disposed with a bellows for preventing or reducing ingress of dirt or moisture into the cable.

According to a still further aspect of the invention for which protection is sought, there is provided a vehicle comprising the automatic transmission described in the foregoing paragraphs or the mechanism described herein above.

According to yet a further aspect of the invention for which protection is sought, there is provided a method of releasing an automatic transmission from a park position comprising;
providing an automatic transmission comprising an electronically activated driving position selector, the driving position selector having a selector shaft and a locking mechanism for locking the selector shaft in a park position;
providing a mechanism for releasing the automatic transmission from a parking position the mechanism having a release lever,
in a first mode the method comprises;
activating the driving position selector electronically,
rotating the selector shaft between a first position in which the automatic transmission is in a parking condition, and second position in which the automatic transmission is disengaged from the parking condition,
where, in the first mode the selector shaft rotates with respect to the release lever between the first and second positions,
in a second mode the method comprises;
activating driving position selector manually,
rotating the release lever in a first direction,
whereby, rotating selector shaft, synchronously with the release lever, between the first position in which the automatic transmission is in the parking condition, and the second position in which the automatic transmission is disengaged from the parking condition.

Optionally, in the second mode the method comprises locking the mechanism to prevent the release lever and selector shaft returning to the first position so as to prevent the automatic transmission engaging the parking condition.

Optionally, in the second mode the method comprises unlocking the mechanism to allow the release lever and selector shaft to return to the first position so as to allow the automatic transmission to engage the parking condition.

Within the scope of this application it is expressly intended that the various aspects, embodiments, examples and alternatives, and in particular the features thereof, set out in the preceding paragraphs, in the claims and/or in the following description and drawings, may be taken independently or in any combination thereof. For example, features described in connection with one embodiment are applicable to all embodiments, unless such features are incompatible.

### BRIEF DESCRIPTION OF THE DRAWINGS

One or more embodiments of the invention will now be described, by way of example only, with reference to the accompanying drawings, in which:

FIG. 1 is a schematic representation of an automatic transmission having an emergency park release mechanism according to an embodiment of the invention;

FIG. 2 is an enlarged view of the emergency park release mechanism of FIG. 1;

FIG. 3 is a perspective view from above of part of the emergency park release mechanism according to an embodiment of the invention;

FIG. 4 is an exploded view of the part of the emergency park release mechanism shown in FIG. 3;

FIG. 5A is a side view of a release lever according to an embodiment of the invention;

FIG. 5B is a top view of a selector shaft according to an embodiment of the invention;

FIG. 5C is an end view of a selector shaft according to an embodiment of the invention;

FIG. 6A is a side view of the part of the emergency park release mechanism shown in FIG. 3 in a first condition;

FIG. 6B is a side view of the part of the emergency park release mechanism shown in FIG. 3 in a second condition;

FIG. 6C is a side view of the part of the emergency park release mechanism shown in FIG. 3 in a third condition;

FIG. 7A is a schematic representation of the profile of a selector shaft according to an embodiment of the invention;

FIG. 7B is a schematic representation of the profile of a selector shaft according to an embodiment of the invention at a first orientation and at a second rotated orientation;

FIG. 7C is a schematic representation of the shape of the aperture defined in the release lever for providing free play according to an embodiment of the invention;

FIG. 7D is a schematic representation of the profile of a selector shaft according to another embodiment of the invention;

FIG. 7E is a schematic representation of the shape of an aperture in a release lever of an emergency park release mechanism for use with the selector shaft of FIG. 7D;

FIG. 7F is a schematic representation of the profile of a selector shaft according to a further embodiment of the invention; and

FIG. 7G is a schematic representation of the shape of an aperture in a release lever of an emergency park release mechanism for use with the selector shaft of FIG. 7F.

### DETAILED DESCRIPTION

Detailed descriptions of specific embodiments of the emergency park release mechanism of the present invention are disclosed herein. It will be understood that the disclosed embodiments are merely examples of the way in which certain aspects of the invention can be implemented and do not represent an exhaustive list of all of the ways the invention may be embodied. Indeed, it will be understood that the emergency park release mechanism described herein may be embodied in various and alternative forms. The figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

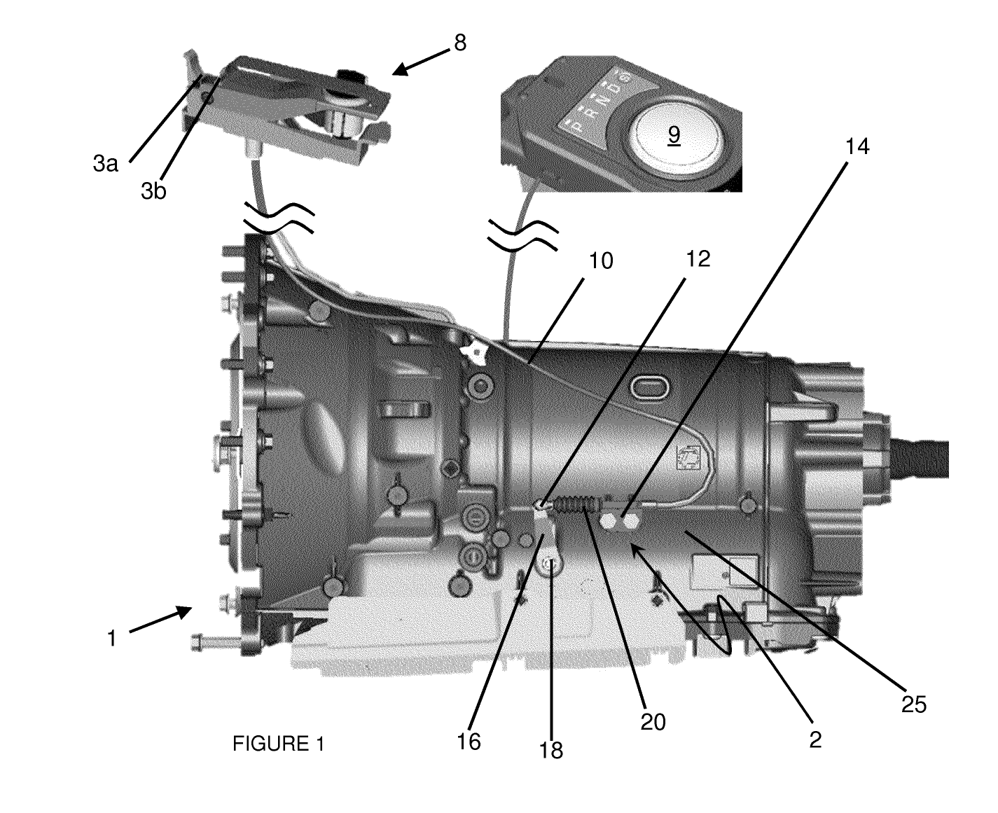

FIG. 1 illustrates schematically a shift-by-wire automatic transmission system 1 including an emergency park release mechanism 2 according to an embodiment of the invention. The automatic transmission 1 is coupled to an electronic driving position selector 9 disposed within the cabin of a vehicle (not shown). The transmission system 1 comprises an actuator (not shown) which is in communication with, electrically coupled, to the electronic driving position selector 9 for selecting between predefined driving positions, including ‘park’, ‘reverse’, ‘neutral’ and ‘drive’. The automatic transmission system 1 comprises a locking mechanism (not shown) for locking the transmission system 1 in a park position. The transmission system 1 comprises resilient biasing means in the form of a park return spring (not shown) for biasing the transmission system 1, in particular a selector shaft 28, to return to the park position, for example in the case of electrical failure, so as to engage with the locking mechanism. In other embodiments the park return spring may be omitted such that the selector shaft 28 remains in the selected driving position at the time of an electrical failure.

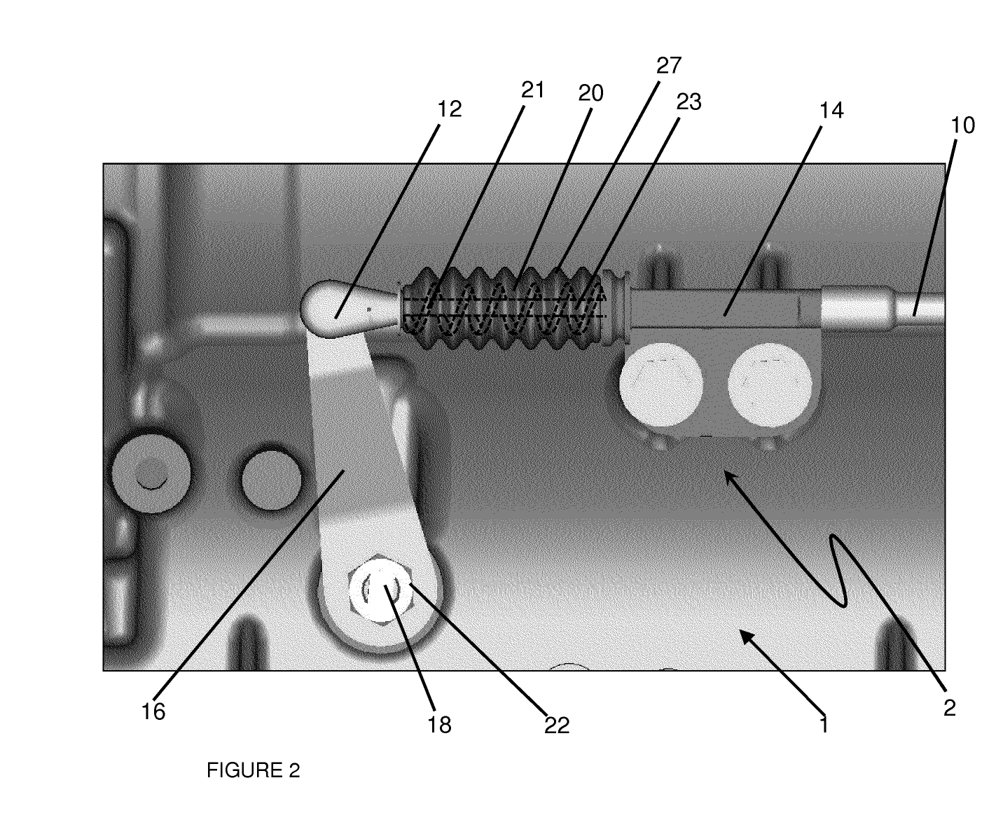

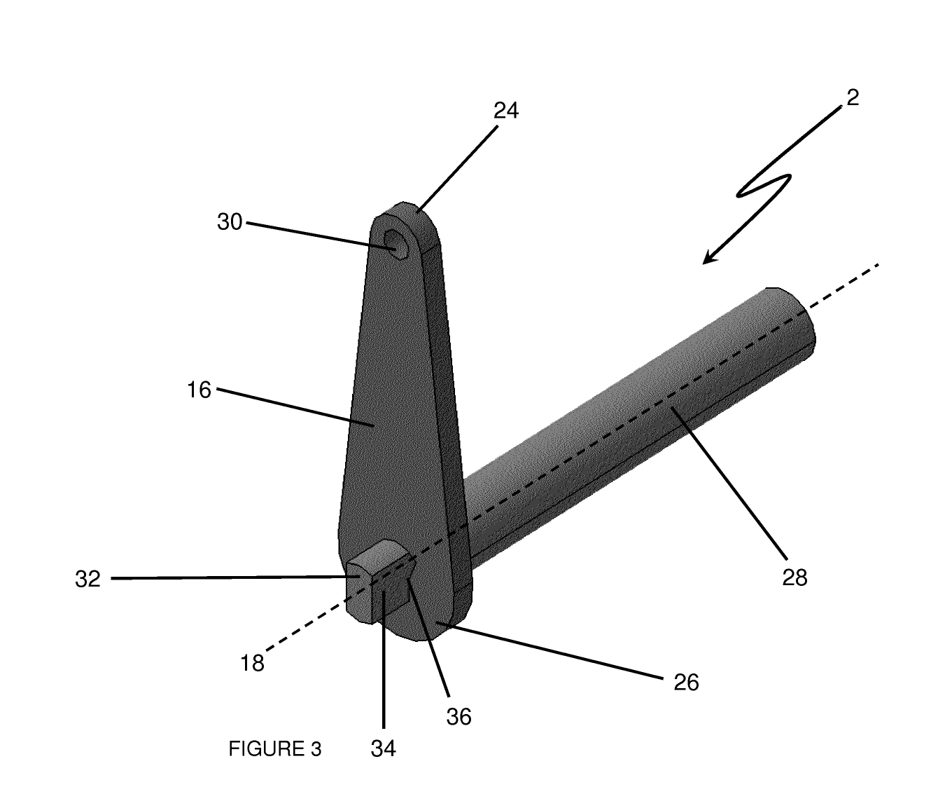

The emergency park release mechanism 2 comprises a lever or handle 8 which is manually operable by a user. The handle 8 may be disposed in the vehicle cabin, preferably in a concealed location so as to prevent inadvertent activation of the emergency park release mechanism 2. In alternative embodiments the handle 8 may be located elsewhere on the vehicle for example in the engine bay or in storage compartment such as the boot or trunk. The handle 8 is coupled to a release lever 16 by a cable 10 such as a Bowden cable. The release lever 16 is mounted upon a selector shaft 28, (best illustrated in FIG. 3) and the selector shaft 28 is rotatable about an axis 18. The cable 10 is mounted to a housing 25 of the automatic transmission 1, optionally by a bracket 14. An end of the cable 10 is coupled to a first end 24 (see FIG. 3) of the release lever 16. The cable 10 is pivotally or rotatably mounted to the first end of the release lever 16. Optionally, the end of the cable 10 comprises a connector 12 (see FIG. 2), for example a socket for receiving a ball mounted on the release lever 16 proximate the first end 24 of the release lever 16. In alternative embodiments a pin or rod may pass through an aperture in the connector 12 mounted on the end of the cable 10. Additionally or alternatively in other embodiments the pin or rod may extend through the release lever 16 such that the release lever 16 may rotate with respect to the connector 12 and cable 10.

The emergency park release mechanism 2 comprises a resilient biasing means in the form of a spring to form a cable return mechanism 20 for overcoming friction in the cable when returning the cable 10 and release lever 16 to a default position, for example the default position is a ‘non-operative’ position, i.e. the release lever position in which the release lever 16 does not disengage the transmission system 1 from the park position. The cable return mechanism 20 comprises a helical spring 21 mounted between the connector 12 and the bracket 14. An inner core 23 of the cable 10 passes through the helical spring so as to extend substantially along a helical axis of the helical spring 21. The inner core 23 of the cable 10 and helical spring 21 are disposed within a sheath in the form of bellows 27 so as to prevent or reduce the ingress of moisture and/or dirt into the cable 10. The bellows 27 is mounted between the connector 12 and the bracket 14.

The release lever 16 is mounted on the selector shaft 28 and secured thereto by a mechanical fixing. Optionally, the mechanical fixing comprises an external screw thread disposed on the end of the selector shaft 28. A nut 22 comprising an internal screw thread complimentary to the external screw thread disposed on the end of the selector shaft 28 is mounted upon the selector shaft 28 so as to retain the release lever 16. Optionally, a washer may be provided between the nut 22 and the release lever 16. The nut 22 may be a locking nut.

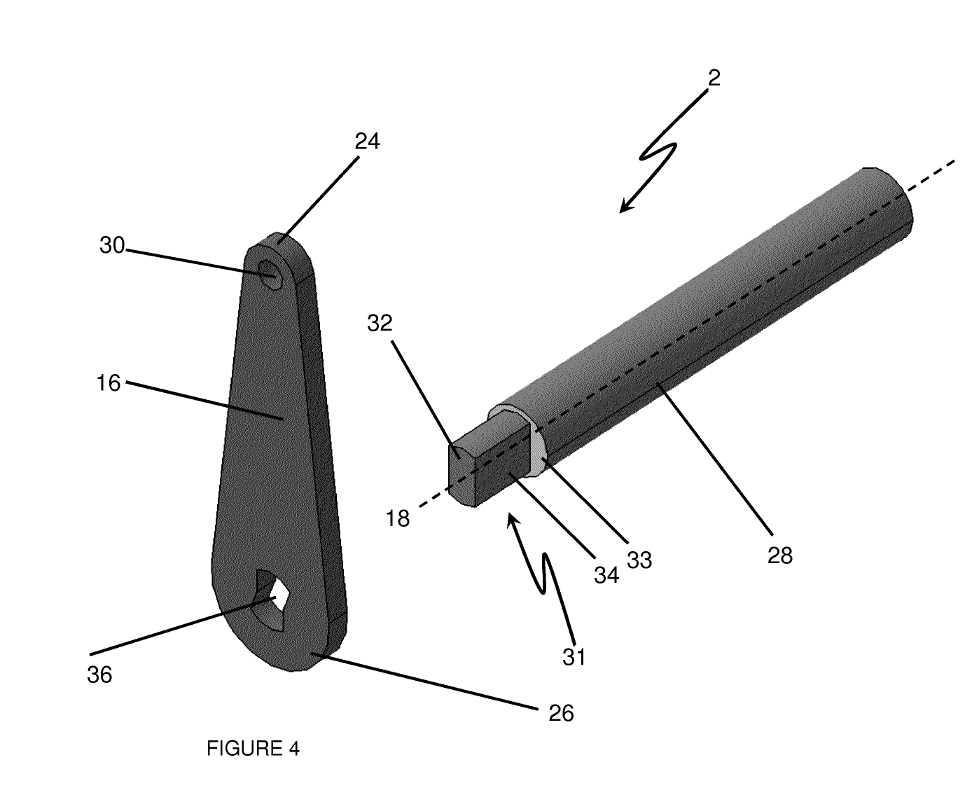

FIGS. 3 to 5C illustrate the release lever 16 and the selector shaft 28. The selector shaft 28 comprises an end section 31 configure to be inserted into the aperture 36 in the release lever 16. The end section 31 comprises a shoulder 33 against which a first side of the release lever 16 abuts, see FIG. 4. The end section 31 comprises a pair of opposing flat sections 34 which extend parallel to the longitudinal axis 18 of the selector shaft 28.

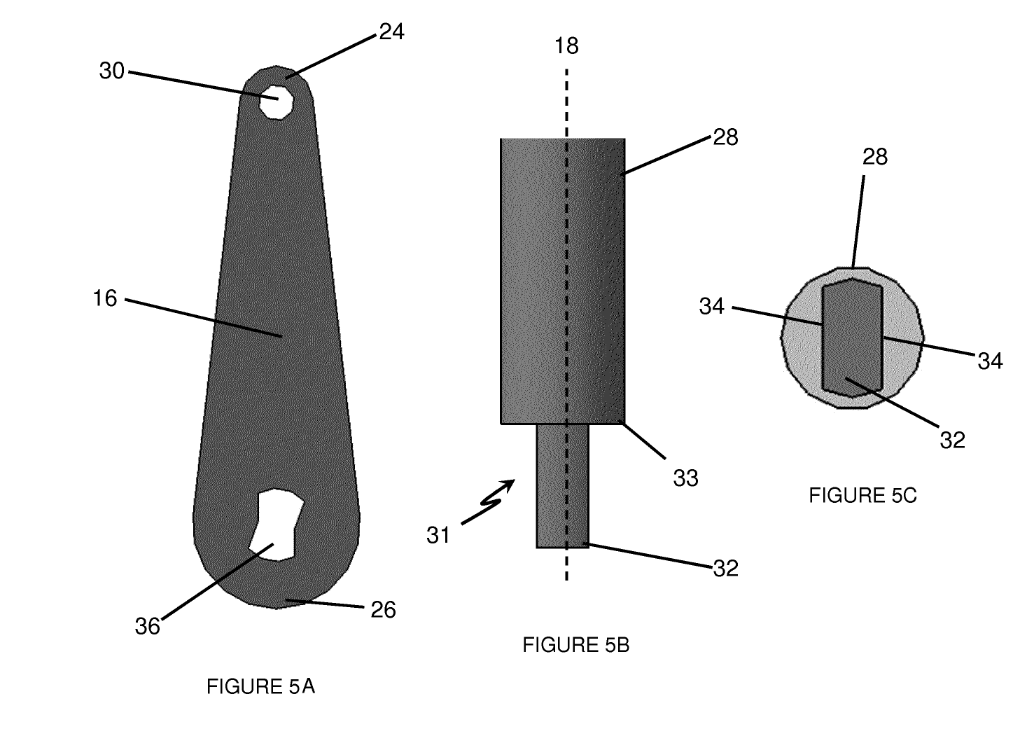

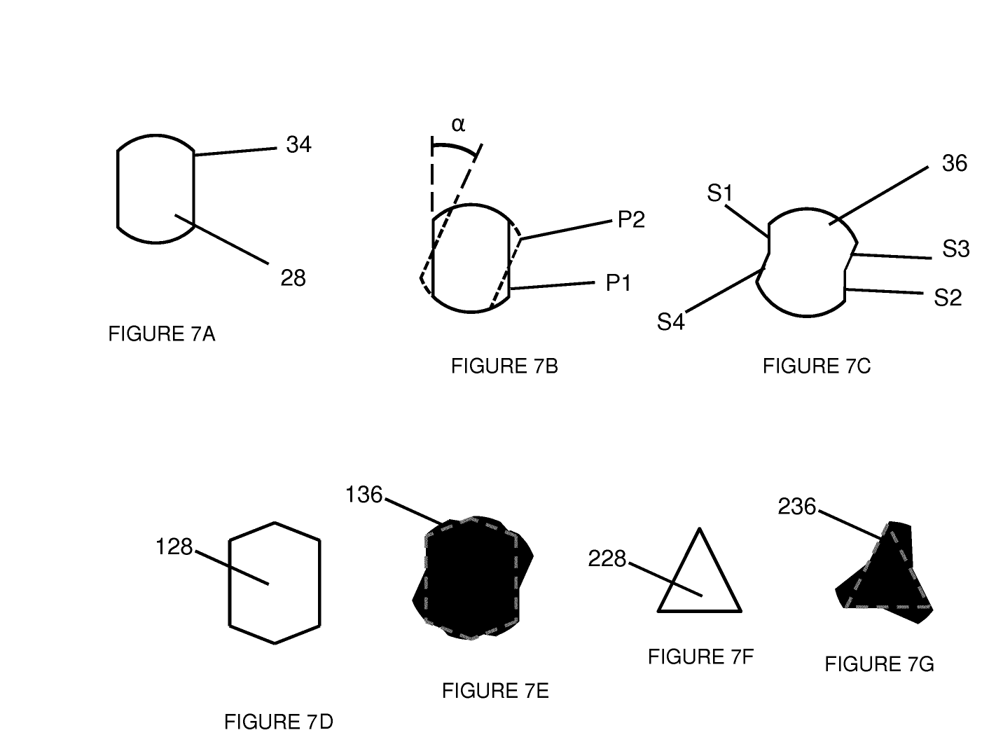

The release lever 16 comprises an aperture 36. In the illustrated embodiment the aperture 36 has a “butterfly” shape, best shown in FIG. 5A. The shape of the aperture 36 is defined by the cross-sectional shape of the end section 31 of the selector shaft 28 and the desired amount of free play to be incorporated. The aperture 36 is a combination of the cross-sectional shape or profile of the end 32 of the selector shaft 28 at a first position P1 and cross-sectional shape or profile of the end 32 of the selector shaft 28 at a second position P2. To get to the second position P2 the selector shaft 28 has been rotated about the longitudinal axis 18 by an angle α, as illustrated in FIG. 7B. The angle α is determined by the angle of rotation of the selector shaft 28 necessary to disengage the automatic transmission from the park position. Optionally, this angle of rotation is up to about 30°, in some embodiments the angle of rotation is between about 20° and about 30° and may be 24°. In other embodiments other angles of rotation are envisaged.

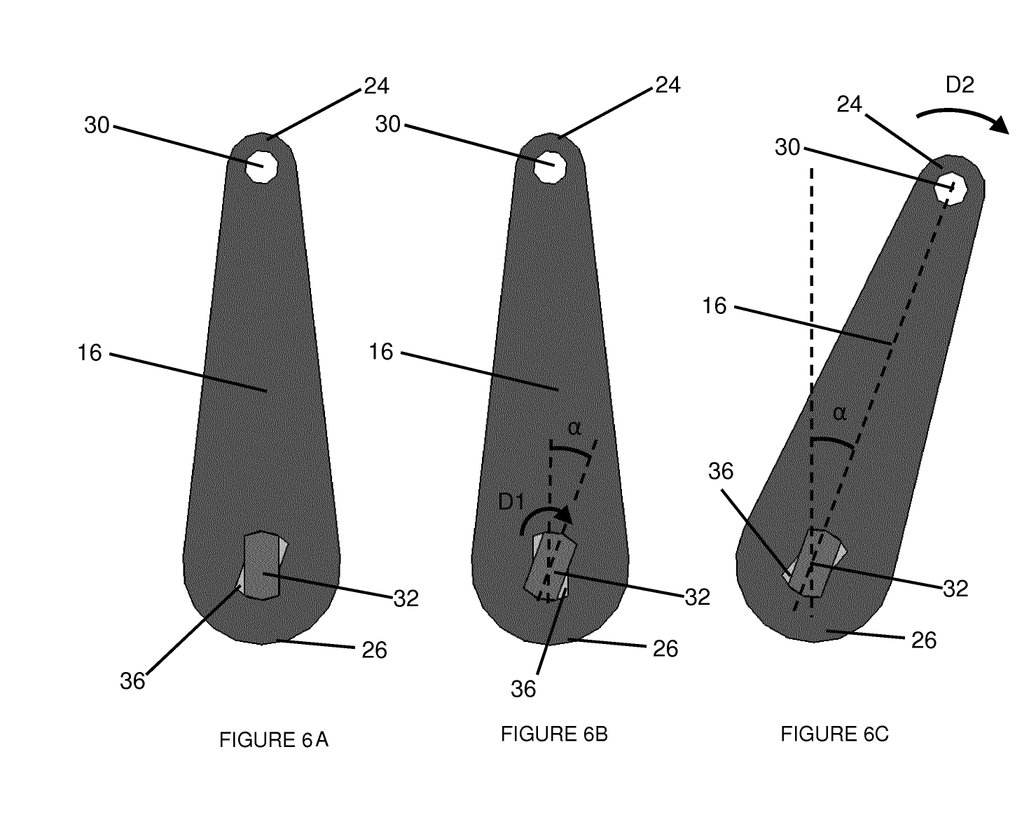

FIGS. 6A, 6B and 6C illustrate the release lever 16 in operation. In FIG. 6A the release lever 16 is in the default inactive condition (i.e. a non-operative position) and the selector shaft 28 is in the park position. In FIG. 6B the release lever 16 is in the default inactive condition and the selector shaft 28 has been rotated, within the aperture 36, in the direction indicated by direction arrow D1. The selector shaft 28 has been rotated through an angle α that is sufficient to disengage the automatic transmission from the park position in which the transmission is locked. It is envisaged that the rotation of the selector shaft 28 will have been initiated by an electronic control unit (not shown) following an input from the driver. This is normal operation of the transmission system 1; the emergency release system 2 is inactive since the transmission system 1 disengages from the park position by employing an electrical actuator (not shown). The electronic control unit will instruct the transmission to disengage park, for example using a mechanical or hydraulic system.

The selector shaft 28 may rotate freely between the first position shown in FIG. 6A and the second position shown in FIG. 6B without causing rotational movement of the release lever 16.

Additionally, the selector shaft 28 may be rotated, from the first position shown in FIG. 6A to the second position shown in FIG. 6C, through an angle α, so as to disengage the automatic transmission from the park position, by rotating the release lever 16 through an angle α as indicated by direction arrow D2 (i.e. by moving the release lever to an operative position). This provides that the transmission system 1 can be manually operated by the emergency park release system 2 to disengage the transmission system 1 from the park position. A user can, by pulling the cable 10, effect rotation of the release lever 16, this in turn acts upon the selector shaft 28 to disengage the transmission system 1 from the park position. In doing so the user overcomes the bias of the park return spring which is acting upon the selector shaft to return the selector shaft 28 to the park position. The release lever 16 and cable 10 must be held or locked in a release position (i.e. the operative position) in order to prevent the park return spring returning the selector shaft 28 to the park position. The release lever 16 and cable 10 may be locked by providing the handle 8 with a locking mechanism 3a/3b at the end of the cable 10 disposed in the vehicle cabin or other location on the vehicle.

The aperture 36 comprises four surfaces S1, S2, S3, S4, as illustrated in FIG. 7C. First surface S1 and second surface S2 engage with the selector shaft 28 to rotate the selector shaft in a first direction, clockwise as illustrated in FIGS. 6A to 6C. The selector shaft 28 when in the park position as illustrated in FIG. 6A is in contact with the first and second surfaces S1, S2. First surface S1 engages with or abuts an upper portion of a first one of the flat sections 34 on a first side of the selector shaft 28, the upper portion being above the longitudinal axis 18 about which the selector shaft 28 rotates. Second surface S2 engages with a lower portion of a second one of the flat sections 34 on a second, opposing, side of the selector shaft 28, the lower portion being below the longitudinal axis 18 about which the selector shaft 28 rotates.

The selector shaft 28 is brought substantially into contact with the third and fourth surfaces S3, S4 when the electronic control unit activates the automatic transmission 1 to rotate the selector shaft 28 to disengage the transmission from the park position, as shown in FIG. 6B.

The selector shaft 28 and the release lever 16 may be returned to the park position shown in FIG. 6a from the disengaged position shown in FIG. 6C by releasing the cable 10, for example by disengaging the locking mechanism provided upon the handle such that the park return spring acts upon the selector shaft 28 to return the selector shaft 28 to the park position. In doing so the selector shaft 28 returns the release lever 16 to the park position as shown in FIG. 6A. The selector shaft 28 acts upon first and second surfaces S1 and S2 of the aperture 36 provided in the release lever 16 to return the release lever 16 to the park position (i.e. such that the release lever is in the non-operative position).

In other embodiments it will be appreciated that the selector shaft 28 may be rotated in the counter-clockwise direction by counter-clockwise rotation of the release lever 16 such that the third and fourth surfaces S3, S4 of the release lever aperture 36 are in contact with the selector shaft 28. Third surface S3 engages or abuts with an upper portion of the second one of the flat sections 34 on the second side of the selector shaft 28, the upper portion being above the longitudinal axis 18 about which the selector shaft 28 rotates. Fourth surface S4 engages with a lower portion of the first one of the flat sections 34 on the first side of the selector shaft 28, the lower portion being below the longitudinal axis 18 about which the selector shaft 28 rotates. It will also be appreciated that to rotate the selector shaft 28 in the counter-clockwise direction from the position illustrated in FIG. 6C it will be necessary to rotate the release lever 16 counter clockwise about an angle α to bring the third and fourth surfaces S3, S4 into contact with the respective portions of the flats 34 of the selector shaft 28 whereby taking up the free play. In order to effect rotation of the selector shaft 28 back to the first, engaged, position, as shown in FIG. 6A the release lever 16 must be rotated counter clockwise about a further angle α.

Other exemplary embodiments of aspects of the invention are illustrated in FIGS. 7D, 7E, 7F, 7G, wherein like reference numerals have, where possible, been used to denote like parts, albeit with the addition of the prefix “100” and “200” to indicate that these features belong to the alternative embodiments respectively.

FIG. 7D illustrates a cross-section of an end portion of a selector shaft 128 according to an alternative embodiment, in this embodiment the selector shaft 128 has a hexagonal shape. FIG. 7E illustrates the shape of an aperture 136 for a release lever (not shown) for incorporating the selector shaft 128 having the hexagonal shape illustrated in FIG. 7D. The aperture 136 includes a predetermined degree of free play, in this example about 24°.

FIG. 7F illustrates a cross-section of an end portion of a selector shaft 228 according to yet another alternative embodiment. In this embodiment the selector shaft 228 has a triangular shape. FIG. 7G illustrates the shape of an aperture 236 for a release lever (not shown) for incorporating the selector shaft 228 having the triangular shape illustrated in FIG. 7F. The aperture 236 includes a predetermined degree of free play, in this example about 24°.

It can be appreciated that various changes may be made within the scope of the present invention, for example, it will be appreciated that in yet other embodiments the selector shaft 28 may have an alternative cross-sectional shape and that the release lever 16 may have an alternatively shaped aperture in dependence upon the shape of the selector shaft 28 and the degree of free play desired. The shape of the aperture 36 can be derived by rotating the cross-sectional shape of the selector shaft 28 through an angle α which provides the desired degree of free play.

Whereas the side 34 of the end portion 31 of the selector shaft 28 are shown as substantially flat in the illustrated embodiments, in alternative embodiments the sides 34 may have another suitable contour and in such embodiments, the aperture of the release lever 16 may have appropriately shaped surfaces S1, S2, S3, S4.

Further it will be appreciated that the maximum degree of free play which can be achieved whilst still providing the aperture 36 with an engaging or driving surface for effecting rotation of the release lever 16 will be limited by the cross-sectional shape of the selector shaft 28. The selector shaft 28 must not be able to rotate continuously in one direction without hindrance from the aperture 36.

In an alternative embodiment (not shown), the aperture 36 may be provided in the end of the selector shaft 28 and a suitably shaped projection (i.e. having a shape corresponding to the end section 31 of the selector shaft 28 in the previously described embodiments of FIGS. 1 to 7G) may be provided proximate to the second end 26 of the release lever 16 to be received within the aperture in the selector shaft. In this alternative embodiment, the relationship between the geometry of the aperture in the selector shaft and the projection on the release lever is the same as for the previously described embodiments in that the aperture is shaped such that the selector shaft is rotatable with respect to the release lever up to a predetermined angle. Rotation on the release lever beyond the predetermined angle causes the selector shaft and release lever to rotate synchronously.

In the case that the aperture 36 is provided in the release lever 16, it has been explained previously that a threaded nut 22 may be mounted on the end of the selector shaft 28 so as to retain the release lever 16 thereon. In the alternative embodiment where the aperture is provided in the end of the selector shaft and the release lever is provided with a projection to be received in the aperture, an alternative mounting arrangement for the release lever is required. For example, the release lever may be rotatably mounted on a bracket or other mounting member attached to the side of the transmission casing. Other arrangements for rotatably mounting the release lever adjacent to the end of the selector shaft are possible.

It will be recognised that as used herein, directional references such as “top”, “bottom”, “front”, “back”, “end”, “side”, “inner”, “outer”, “upper” and “lower” do not limit the respective panels to such orientation, but merely serve to distinguish these panels from one another.

1. A mechanism for releasing an electronically controlled automatic transmission from a parking position, the automatic transmission comprising a selector shaft for selecting an operating position of the automatic transmission, the mechanism comprising a manual actuator coupled to a release lever by a cable, wherein the release lever is mounted upon the selector shaft and comprises an aperture for receiving the selector shaft, wherein the aperture is shaped such that the selector shaft is rotatable with respect to the release lever up to a predetermined angle.

2. The mechanism of claim 1, wherein the selector shaft is rotatable between a first position in which the automatic transmission is in a parking position and a second position in which the automatic transmission is disengaged from the parking position without rotating the release lever.

3. (canceled)

4. The mechanism of claim 1, wherein the aperture is shaped such that further rotation of either one of the release lever or selector shaft causes both the release lever and selector shaft to rotate synchronously.

5. The mechanism of claim 2, wherein the aperture shape is a combination of a cross-sectional shape of the selector shaft at the first position and a cross-sectional shape of the selector shaft after rotation to the second position.

6. The mechanism of claim 1, wherein the aperture is substantially butterfly shaped.

7. The mechanism of claim 1, wherein the aperture comprises a first pair of diagonally opposed surfaces for engaging opposing sides of the selector shaft for rotating the selector shaft in a first direction and wherein the diagonally opposed surfaces are arranged so as to engage the selector shaft on opposing sides of a rotational axis of the selector shaft.

8. The mechanism of claim 7, wherein the aperture comprises a second pair of diagonally opposed surfaces for engaging on opposing sides of the selector shaft for rotating the selector shaft in a second direction and wherein the second pair of diagonally opposed surfaces are arranged so as to engage the selector shaft on opposing sides of the rotational axis of the selector shaft.

9. The mechanism of claim 8, wherein only one pair of the first and second pairs of diagonally opposed surfaces is engaged with the selector shaft when the selector shaft is rotated in either of the first or second directions.

10. The mechanism of claim 1, wherein the release lever is mounted upon the selector shaft proximate to a first end thereof and to the cable proximate to a second end thereof, and wherein the cable is configured to pull the second end of the release lever thereby rotating the release lever about a rotational axis of the selector shaft.

11. The mechanism of claim 2, further comprising a cable return spring for biasing the cable and the release lever to a non-operative position.

12. (canceled)

13. The mechanism of claim 2, wherein the manual actuator comprises a latching device for retaining the manual actuator, the cable and the release lever in an operative position when actuated, so as to maintain the selector shaft in the second position.

14. The mechanism of claim 7, wherein, when the release lever is disposed in a non-operative position, the first pair of diagonally opposed surfaces is substantially disposed in engagement with the selector shaft when disposed in a parking position such that the selector shaft rotates substantially simultaneously with the release lever when rotated in the first direction.

15. A driving position selector for an electronically controlled automatic transmission comprising the mechanism of claim 1.

16. An automatic transmission for a vehicle comprising an electronically activated driving position selector having the mechanism of claim 1.

17. The automatic transmission of claim 16, further comprising a housing, wherein the selector shaft extends through the housing and the cable is slidably mounted within a bracket mounted upon the housing.

18. The automatic transmission of claim 17, further comprising a cable return spring that biases the cable and the release lever to a non-operative position, wherein the cable comprises an end connector for coupling the cable to the release lever and the cable return spring is mounted between the end connector and the bracket, and wherein the cable return spring comprises a bellows for preventing or reducing ingress of dirt or moisture.

19. (canceled)

20. A vehicle comprising the mechanism of claim 1.

21. A method of releasing an automatic transmission from a park position, the method comprising:
providing an automatic transmission comprising an electronically activated driving position selector, the driving position selector having a selector shaft and a locking mechanism for locking the selector shaft in a park position; and
providing a mechanism for releasing the automatic transmission from a parking position, the mechanism having a release lever;
wherein, in a first mode, the method comprises:
activating the driving position selector electronically;
rotating the selector shaft between a first position in which the automatic transmission is in a parking condition, and second position in which the automatic transmission is disengaged from the parking condition;
where, in the first mode the selector shaft rotates with respect to the release lever between the first and second positions; and
wherein, in a second mode, the method comprises:
activating the driving position selector manually;
rotating the release lever in a first direction;
thereby rotating the selector shaft, synchronously with the release lever, between the first position in which the automatic transmission is in the parking condition, and the second position in which the automatic transmission is disengaged from the parking condition.

22. The method of claim 21, wherein, in the second mode, the method comprises locking the mechanism to prevent the release lever and selector shaft returning to the first position so as to prevent the automatic transmission engaging the parking condition.

23. The method of claim 22, wherein, in the second mode, the method further comprises unlocking the mechanism to allow the release lever and selector shaft to return to the first position so as to allow the automatic transmission to engage the parking condition.

24-25. (canceled)
